(19) United States
(12) Patent Application Publication
(10) Pub. No.: US 2026/0132043 A1
(43) Pub. Date: May 14, 2026

(54) TREATMENTS FOR ZINC TELLURIDE PHOTOABSORBERS

(71) Applicant: Alliance for Sustainable Energy, LLC, Golden, CO (US)

(72) Inventors: Christopher Paul MUZZILLO, Evergreen, CO (US); Andriy ZAKUTAYEV, Boulder, CO (US)

(21) Appl. No.: 19/384,437

(22) Filed: Nov. 10, 2025

Related U.S. Application Data
(60) Provisional application No. 63/718,053, filed on Nov. 8, 2024.

(51) Int. Cl. C01G 11/00; C01F 5/30; C01G 9/00; C01G 45/00; C25B 1/23; C25B 1/55; C25B 11/067; C25B 11/073

(52) U.S. Cl. CPC C01G 11/006; C01F 5/30; C01G 9/006; C01G 45/00; C25B 1/23; C25B 1/55; C25B 11/067; C25B 11/073; C01P 2006/40

(57) ABSTRACT

The present disclosure relates to a method that includes treating a layer of ZnTe with a metal halide, where the layer has a first grain size between 25 nm and 250 nm before the treating and the layer has a second grain size after the treating that is larger than the first grain size. In some embodiments of the present disclosure, the ZnTe may include at least one of Zn_{1-w}Cd_{w}Te, ZnTe₁₋ₓSeₓ, Zn_{1-y}Cd_{y}Te_{1-z}Se_{z}, or a combination thereof and each of w, x, y, and z are independently between 0 and 0.9, inclusively.

### CROSS-REFERENCE TO RELATED APPLICATIONS

This application claims the benefit of U.S. Provisional Patent Application No. 63/718,053 filed Nov. 8, 2024, the contents of which are incorporated herein by reference in their entirety.

### CONTRACTUAL ORIGIN

This invention was made with government support under Contract No. DE-AC36-08GO28308 awarded by the Department of Energy. The government has certain rights in the invention.

### BACKGROUND

Long-haul aviation and other demanding sectors of the economy require hydrocarbon fuels, which makes the complete elimination of carbon-based liquid fuels difficult. Instead, CO₂ captured from the atmosphere can be sourced to create carbon-neutral fuel. However, converting CO₂ into usable products is energy intensive. To potentially solve these issues, the prospect of harvesting sunlight to directly drive the photoelectrochemical carbon dioxide reduction reaction (PEC CO₂ RR) is technologically interesting. Thus, there remains a need for developing improved methods, compositions, and devices that enable the reliable and economically viable conversion of CO₂ to usable products, including fuels and chemicals.

### SUMMARY

An aspect of the present disclosure is a method that includes treating a layer of ZnTe with a metal halide, where the layer has a first grain size between 25 nm and 250 nm before the treating and the layer has a second grain size after the treating that is larger than the first grain size. In some embodiments of the present disclosure, the ZnTe may include at least one of Zn_{1-w}Cd_{w}Te, ZnTe₁₋ₓSeₓ, Zn_{1-y}Cd_{y}Te_{1-z}Se_{z}, or a combination thereof and each of w, x, y, and z are independently between 0 and 0.9, inclusively.

In some embodiments of the present disclosure, the metal of the metal halide may include at least one of magnesium, manganese, or a combination thereof. In some embodiments of the present disclosure, the halide of the metal halide may include at least one of chloride, bromide, iodide, or a combination thereof. In some embodiments of the present disclosure, the metal chloride may include at least one of MnCl₂, MgCl₂, or a combination thereof. In some embodiments of the present disclosure, the second grain size may be between 50 nm and 1,000 nm.

In some embodiments of the present disclosure, the treating may be performed by close space sublimation. In some embodiments of the present disclosure, the treating may be performed with the layer at a first temperature between 300° C. and 600° C. In some embodiments of the present disclosure, the treating may be performed at a pressure between 1 Torr and 1,520 Torr. In some embodiments of the present disclosure, the treating may be performed in a gaseous environment comprising the metal halide. In some embodiments of the present disclosure, the gaseous environment may further include at least one of He, Ar, H₂, H₂O, O₂, N₂, HCl, or a combination thereof. In some embodiments of the present disclosure, the gaseous environment may further include H₂. In some embodiments of the present disclosure, a concentration of H₂ in the gaseous environment may be between 0.5 vol % and 10 vol %.

In some embodiments of the present disclosure, a method may further include, prior to the treating, loading a solid of the metal halide into a bottom portion of a container and heating the solid to a second temperature, where the second temperature is higher than the first temperature, and the heating converts the solid to a gas. In some embodiments of the present disclosure, the treating may enhance a photoluminescence band-edge-to-defect emission ratio of the layer. In some embodiments of the present disclosure, a method may further include, after the treating, depositing a catalyst layer on the ZnTe layer resulting from the treating. In some embodiments of the present disclosure, the catalyst layer may include at least one of copper, silver, gold, or a combination thereof.

An aspect of the present disclosure is a composition that includes a layer of ZnTe, where the layer includes grains having a grain size between 50 nm and 1,000 nm or between 50 nm and 500 nm.

An aspect of the present disclosure is a device that includes a cathode having a layer of ZnTe, where the layer has a grain size between 50 nm and 500 nm, and the device is capable of demonstrating an increased photocurrent density and Faradaic efficiency for the photoelectrochemical reduction of CO₂ to CO. In some embodiments of the present disclosure, a device may further include an electrolyte and an anode, where the cathode and the anode are positioned within the electrolyte.

### BRIEF DESCRIPTION OF DRAWINGS

Some embodiments are illustrated in referenced figures of the drawings. It is intended that the embodiments and figures disclosed herein are to be considered illustrative rather than limiting.

FIG. 1 illustrates a process schematic of a system for treating ZnTe layers with a metal halide, according to some embodiments of the present disclosure.

FIG. 2 illustrates a method for treating ZnTe layers with a metal halide, according to some embodiments of the present disclosure.

FIG. 3 illustrates a device that incorporates ZnTe layers configured to complete the photoelectrochemical reduction of CO₂, according to some embodiments of the present disclosure.

FIG. 4 illustrates vapor pressure (left axis atm; right axis kPa) as a function of temperature (bottom axis K; top axis ° C.) for ZnCl₂, CdCl₂, MnCl₂, and MgCl₂, showing that MnCl₂ and MgCl₂ have much lower relative volatility.

FIG. 5 illustrates XRF data showing the change in ZnTe layer thickness, Mn, and Cl composition after MnCl₂ treatments as a function of substrate temperature, showing substrate temperatures above 435° C. etch the ZnTe, according to some embodiments of the present disclosure.

FIG. 6 illustrates XRF data showing the change in ZnTe layer thickness, Te, and Zn composition after a 390° C. anneal, 435° C. anneal, 435° C. MnCl₂ treatment, or 390° C. MgCl₂ treatment, showing that anneals cause slight Te loss, while chloride treatments cause more significant Zn loss, etching the layer, according to some embodiments of the present disclosure.

FIG. 7 illustrates XRF data showing the change in ZnTe layer thickness, Te, and Zn composition after a 435° C. MnCl₂ treatment with low or high H₂O, or 390° C. MgCl₂ treatment with low or high H₂O, showing that the 3 H₂O molecules desorbed during the MnCl₂·4H₂O pre-bake have a small effect on etching, while the 6 H₂O molecules desorbed during the MgCl₂·6H₂O pre-bake have a strong effect on etching, according to some embodiments of the present disclosure.

FIG. 8 illustrates PL for 435° C. MnCl₂ and 390° C. MgCl₂ samples with new (dark lines) and old (light lines) source material (new and old MnCl₂ were exposed to high temperature for 4.5 h and 6.5 h, respectively; new and old MgCl₂ were exposed to high temperature for 1 h and 4.5 h, respectively), showing that the sources become less effective with high temperature exposure, probably due to chlorine loss via HCl formation.

FIG. 9 illustrates scanning electron micrographs showing the (Panel a) as deposited, (Panel b) 390° C. anneal, (Panel c) 435° C. anneal, (Panel e) 390° C. MgCl₂, and (Panel f) 435° C. MnCl₂ samples in plan view, showing that the chloride treatments increase grain size and form smoother surfaces, relative to the anneals, according to some embodiments of the present disclosure. Panel d) illustrates photographs of as deposited (left) and 435° C. MnCl₂ (right) samples.

FIG. 10 illustrates XRD for the as deposited, 435° C. anneal, 435° C. MnCl₂, and 390° C. MgCl₂ samples and ICDD powder reference, with closeups of the ZnTe(111), according to some embodiments of the present disclosure.

FIG. 11A illustrates UV/visible spectroscopy for the as deposited (2.02 eV), 435° C. anneal (2.13 eV), 435° C. MnCl₂ (2.16 eV), and 390° C. MgCl₂ (2.18 eV) samples with fits to their linear regions extrapolated to give band gaps, showing that annealing sharpens the absorption onset and the chloride treatments sharpen it even more, according to some embodiments of the present disclosure.

FIG. 11B illustrates PL data for the as deposited, 435° C. anneal, 435° C. MnCl₂, and 390° C. MgCl₂ samples, showing that annealing enhances the defect PL emission at 1.75 eV, while chloride treatments enhance band edge PL emission at 2.25 eV, relative to the anneals, according to some embodiments of the present disclosure.

FIG. 12 illustrates UV/visible spectroscopy absorption coefficient for the as deposited, 435° C. anneal, 435° C. MnCl₂, and 390° C. MgCl₂ samples, showing that annealing sharpens the absorption onset and the chloride treatments sharpen it even more, according to some embodiments of the present disclosure.

FIG. 13 illustrates PEC current density-voltage data without and with 10 mM diaryliodonium additive for the as deposited (Panel a) and (Panel c), and 435° C. MnCl₂ (Panel b) and (Panel d) samples, respectively, according to some embodiments of the present disclosure. The cathodic and anodic 1^{st}, 2^{nd} and 3^{rd} sweeps are plotted, showing that the MnCl₂ sample with additive has improved photocurrent density.

FIG. 14 illustrates PEC current density-voltage data without and with 10 mM diaryliodonium additive for the as deposited (Panel a) and (e), 435° C. anneal (Panel b) and (Panel f), 435° C. MnCl₂ (Panel c) and (Panel g), and 390° C. MgCl₂ (Panel d) and (Panel h) samples, respectively, according to some embodiments of the present disclosure. The cathodic and anodic 1^{st}, 2^{nd}, and 3^{rd} sweeps are plotted, showing that the MnCl₂ sample with additive has the greatest photocurrent density: −1.5 mA/cm² at −1.0 V vs RHE and 11 mW/cm² illumination with a 455 nm LED.

FIG. 15 illustrates CV scans chopped illumination for the bare F:SnO₂ substrate, according to some embodiments of the present disclosure. The test was operated with 0.1 M KHCO₃ electrolyte without additives, 455 nm light-emitting diode illumination at 11 mW/cm², and 10 mV/s sweeps from +0.2 to −1.0 V vs reversible hydrogen electrode (RHE). This substrate shows only dark current at potential more negative than −0.7 V vs RHE and no photocurrent.

FIG. 16 illustrates a picture of post-PEC run ZnTe samples, according to some embodiments of the present disclosure.

FIG. 17 illustrates ICP-MS results for post-PEC run electrolytes (circles), showing very little ZnTe dissolution compared to the pre-PEC electrolyte (star symbols), indicating that the ZnTe is stable for most sample types and conditions tested, according to some embodiments of the present disclosure.

FIG. 18 illustrates Faradaic efficiency (left axis) and current density (right axis) for the as deposited (1^{st} bars; squares), 435° C. anneal (2^{nd} bars; stars), 435° C. MnCl₂ (3^{rd} bars; triangles), and 390° C. MgCl₂ (4^{th} bars; circles) samples without (Panel a) and with 10 mM diaryliodonium additive (Panel b) as a function of potential vs RHE, showing that the additive enhances the Faradaic efficiency of CO formation for all sample types and the MnCl₂ sample with additive at −1.0 V vs RHE has the best photocurrent density and faradaic efficiency (−1.5 mA/cm² and 50.4%, respectively), according to some embodiments of the present disclosure.

FIG. 19A illustrates PL data for an as deposited ZnTe layer, according to some embodiments of the present disclosure.

FIG. 19B illustrates PL data for a ZnTe layer after a 435° C. anneal, according to some embodiments of the present disclosure.

FIG. 19C illustrates PL data for a ZnTe layer after a 435° C. anneal in the presence of 435° C. MnCl₂, according to some embodiments of the present disclosure.

FIG. 19D illustrates PL data for a ZnTe layer after a 435° C. anneal in the presence of 390° C. MgCl₂, according to some embodiments of the present disclosure.

FIG. 20 illustrates faradaic efficiency (left axis) and current density (right axis) for the as deposited (1^{st} bars; squares), and 435° C. MnCl₂ (2^{nd} bars; triangles) samples without (Panel a) and with 10 mM diaryliodonium additive (Panel b) as a function of potential vs RHE, showing that the MnCl₂ sample with additive at −1.0 V vs RHE has the best photocurrent density and faradaic efficiency (−1.5 mA/cm² and 50.4%, respectively).

To facilitate understanding, identical reference numerals have been used, where possible, to designate identical elements that are common to the figures. It is contemplated that elements and features of one embodiment may be beneficially incorporated in other embodiments without further recitation.

### REFERENCE NUMERALS

| | |
|---|---|
| 100 | reactor |
| 120 | stack |
| 122 | substrate |
| 124 | ZnTe layer |
| 130 | container |
| 132 | bottom portion |
| 134 | lid |
| 136 | space |
| 140 | solid metal halide |
| 150 | spacer |
| 160 | lamp |
| 200 | method |
| 202 | ZnTe precursors |
| 210 | depositing |
| 220 | treating |
| 300 | device |
| 310 | cathode |
| 320 | anode |
| 330 | electrolyte |
| 340 | permeable exchange membrane |
| 350 | reference electrode |

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present disclosure relates to methods for treating ZnTe and/or ZnTe alloys referred to herein collectively as ZnTe layers, that, in addition to zinc and tellurium, also include at least one of cadmium, selenium, or combinations thereof, to yield ZnTe layers having superior photovoltaic and/or photoelectrochemical properties and/or performance metrics. As shown herein, such materials, compositions, and devices containing them can provide superior physical properties and/or performance metrics suited for the photoelectrochemical conversion of CO₂ to fuels and other useful products.

In some embodiments of the present disclosure, a method includes treating a starting ZnTe layer with a component that includes a metal halide, where the halide includes at least one of fluorine, chloride, bromine, and/or iodine. Examples of ZnTe alloys that may be provided in a starting layer include ZnTe alloys that include at least one of cadmium, selenium, sulfur, mercury, and/or zinc. Specific examples of ZnTe alloys with cadmium and/or selenium include Zn_{1-w}Cd_{w}Te, ZnTe₁₋ₓSeₓ, and/or Zn_{1-y}Cd_{y}Te_{1-z}Se_{z} where w, x, y, and z, are each independently between 0 and 0.99, or between 0 and 0.98, or between 0 and 0.97, or between 0 and 0.96, or between 0 and 0.95, or between 0 and 0.9, inclusively.

As shown here, treating a starting layer of ZnTe with a metal halide can result in, among other things, a treated ZnTe layer characterized by an increase in the size of the ZnTe crystals, i.e., grains, relative to those of the initial, untreated, starting ZnTe crystals. As defined herein, grain size is defined as the median diameter of the single crystalline domains making up a polycrystalline layer as viewed in a reference plane, e.g., a surface as seen in a scanning electron microscopy image or a cross-section as seen in a transmission electron microscopy image. For example, a ZnTe layer may have a grain size between 25 nm and 250 nm, before a treatment step with a metal halide, whereas after the treating step, the resultant ZnTe layer may be characterized by grains having significantly larger sizes. In some embodiments of the present disclosure, the grain size of a treated ZnTe layer, after treatment with a metal halide, may be between 50 nm and 1,000 nm, or between 50 nm and 900 nm, or between 50 nm and 500 nm, or between 50 nm and 250 nm. In some embodiments of the present disclosure, with sufficient chloride treatment time at temperature (e.g., 30 minutes at ˜435° C. for MnCl₂ or 30 minutes at ˜390° C. for MgCl₂), a ZnTe grain may have a grain size equal to the thickness of the resultant ZnTe. Thus, a ZnTe layer may include a plurality of grains that span the entire thickness of the ZnTe layer before or after the chloride treatment. As shown herein, this increase in grain size correlates with improved performance characteristics of photoelectrochemical devices that utilize the treated layers having the larger ZnTe grains.

In some embodiments of the present disclosure, a metal halide for contacting (i.e., treating) with a starting ZnTe layer may include at least one of MnCl₂, MgCl₂, or a combination thereof. More generally, a metal halide for use in the methods described herein may be selected based on its vapor pressure. Specifically, a metal halide may preferentially have a vapor pressure that is lower than the vapor pressure of ZnX₂, for example ZnCl₂, when a metal chloride is used for the treating step. Further, a metal halide may be selected that results in a positive Gibbs free energy of reaction with the ZnTe or the ZnTe alloy. The positive Gibbs energy of reaction is preferred so that the reaction does not proceed to the point where the layer is etched. A low vapor pressure is preferred so that the starting ZnTe layer can absorb the metal halide at a high temperature for times long enough for the reaction to occur. Higher vapor pressure chemicals like ZnCl₂ are lost too fast to react.

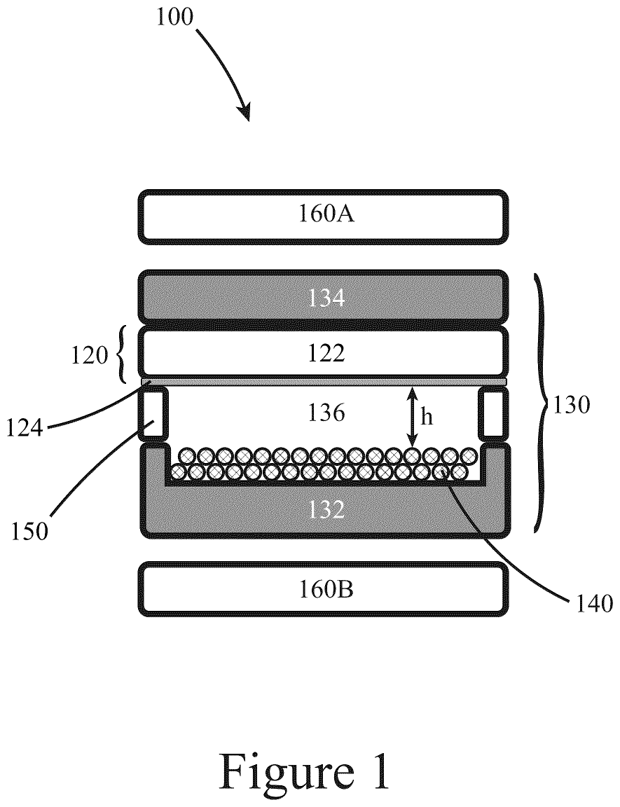

In some embodiments of the present disclosure, close space sublimation may be performed to contact a starting ZnTe layer with a metal halide, e.g. MnCl₂ and/or MgCl₂. A reactor 100 suitable for close space sublimation is illustrated in FIG. 1. As shown, a reactor 100 may include a container 130 constructed of a bottom portion 132, a lid 134, and a spacer 150. The bottom portion 132 and the lid 134 may be detachable and, by use of the spacer 150, can be connected together to form an isolated internal space 136. A bottom portion 132 may include a sidewall that forms a depression into which the metal halide solid 140 may be placed.

Referring again to FIG. 1, in some embodiments of the present disclosure, a starting ZnTe layer 124 may be deposited onto a substrate 122 to form a stack 120. This depositing is typically done in a separate system (not shown). For example, the depositing of a starting ZnTe layer onto a substrate may be performed by at least one of radio frequency sputtering, molecular beam epitaxy, chemical vapor deposition, pulsed laser deposition, or a combination thereof. Examples of materials suitable for a substrate 122 include at least one of a glass, SiO₂, SnO₂, a fluorine-doped SnO₂, a polymer foil, a metal foil, silicon, or a combination thereof. Further, the depositing of a starting ZnTe layer 124 onto a substrate 122 may be achieved using solution processing methods. An example of a solution processing is the hydrothermal growth of ZnTe using Zn foil in water containing a Te precursor such as NaTeO₃ and NaBH₄.

Regardless, once deposited, the resultant stack 120 (substrate/starting ZnTe layer) may be placed into a reactor 100 by positioning the stack 120 between the lid 134 and the spacer 150. A metal halide solid 140 may be placed into the bottom portion 132. The metal halide solid 140 and the stack 120 (with the starting ZnTe layer 124) may then be brought into close contact by stacking the bottom portion 132, the spacer 150, the stack 120, and the lid 134 on top of each other. Referring again to FIG. 1, a surface of the starting ZnTe layer 124 is positioned to face a surface of the metal halide solid 140 positioned in the bottom portion 132. This orientation enables the mass transfer of gaseous metal halide from the metal halide solid 140 to the surface of the starting ZnTe layer 124. As shown in FIG. 1, the physical distance between the metal halide solid 140 and/or the bottom surface of the bottom portion 132 may be adjusted by varying at least one of the height of the sidewall of the bottom portion 132 and/or the height of the spacer 150. In some embodiments of the present disclosure, this distance, indicated as h in FIG. 1, may be in a range between greater than 0 mm and 5 mm or 0.25 mm to 3 mm. The halide source 140 thickness is between 0.5 mm and 5 mm, or between 2 mm and 3 mm.

The space 136 positioned within the container 130 of a reactor 100 may be filled with an inert gas, followed by independently heating the starting stack 120 (substrate/starting ZnTe layer) and the bottom portion 132 containing the metal halide solid 140, e.g., MnX₂ and/or MgX₂, where X is one or more halides. By intentionally heating the stack 120 to a temperature that is lower than the bottom portion 132 containing the metal halide solid 140, the metal halide may be sublimed from the bottom portion 132, resulting in the transfer of gaseous metal halide to the adjacent surface of the starting ZnTe layer 124. In some embodiments of the present disclosure, a starting ZnTe layer 124 (e.g., ZnTe and/or the ZnTe alloy layer) may have a thickness between 0.1 μm and 5 μm, both before and after the treating of the ZnTe layer 124 with the gaseous metal halide. Thus, in some embodiments of the present disclosure, the starting thickness of a ZnTe layer 124 before treating and the thickness after treating may be approximately equal. Further, as described above, the grain size of grains making up a ZnTe layer 124 may be, after treating with a metal halide, approximately equal to the thickness of the ZnTe layer 124. Thus, in some embodiments of the present disclosure, the median grain size of grains making up ZnTe layer 124 resulting from treating a starting layer with a metal halide may be between 0.1 μm and 5 μm, in the thickness direction of the ZnTe layer 124. Typically, the heat provided during a treating step is sufficient for converting a starting ZnTe layer to a converted ZnTe layer having improved grain sizes, physical properties, and performance metrics. In some embodiments of the present disclosure, a method may further include a subsequent annealing process, in the absence of a metal halide.

In some embodiments of the present disclosure, the treating of a starting ZnTe layer 124 with a gaseous metal halide may be performed with the ZnTe layer 124 maintained at a first temperature between 300° C. and 600° C. or between 365° C. and 515° C. or less than about 435° C. and with the bottom portion 132 containing the metal halide solid 140 maintained at a second temperature that is higher than the first temperature. Arrays of 1 kW tungsten-halogen lamps are used to independently control the temperature of the bottom portion 132 and lid 134 in a cold-wall quartz reactor, allowing the metal halide source 140 to be hotter than the ZnTe layer 124. In some embodiments of the present disclosure, a second temperature may be between 10° C. and 100° C. higher than the first temperature, or between 25° C. and 55° C. higher than the first temperature. Thus, in some embodiments of the present disclosure a second temperature may be between 310° C. and 700° C. or between 375° C. and 615° C. or less than about 445° C. In some embodiments of the present disclosure, the treating may be performed at a pressure in the space 136 within the reactor 100 between 1 Torr and 1,520 Torr or between 100 Torr and 800 Torr. In some embodiments of the present disclosure, the atmosphere (i.e., within the space 136) in a reactor 100 may include at least one of He, Ar, H₂, H₂O, O₂, N₂, HCl, or a combination thereof.

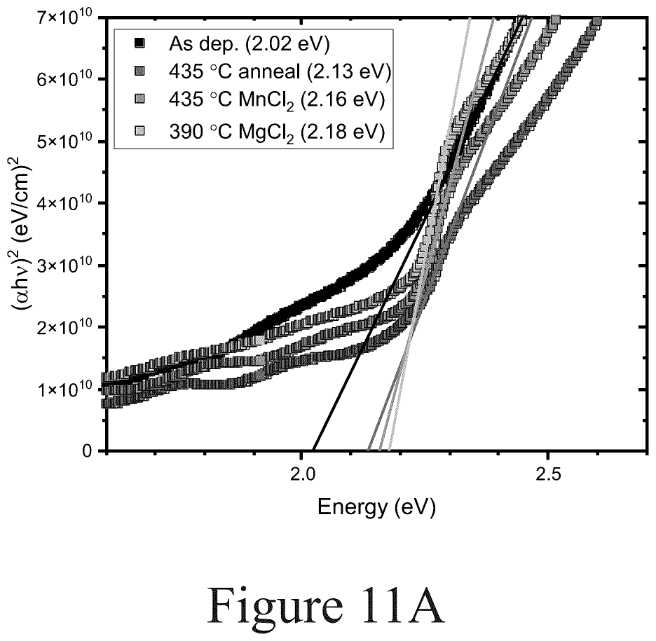

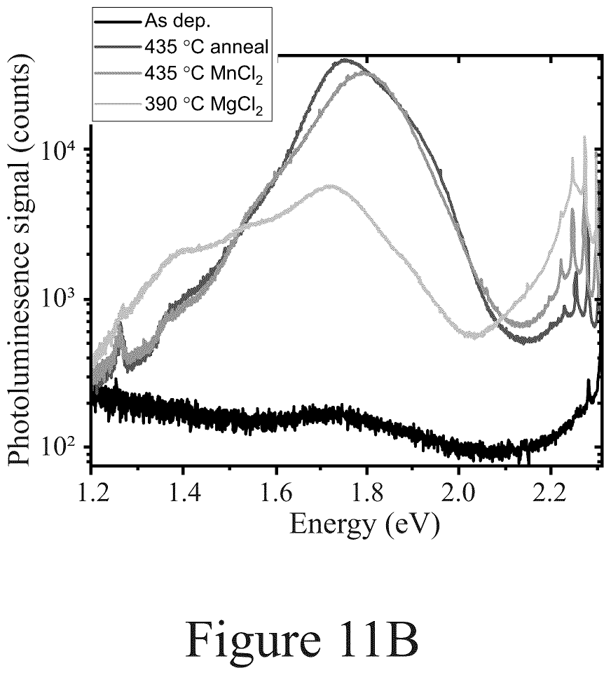

A ZnTe layer resulting from the methods described above, may be characterized by several physical properties and/or performance metrics. First, as described above, the resultant ZnTe layer may be characterized by an average and/or median grain size that is greater than the grains present in starting ZnTe layer. Further, a resultant ZnTe layer may have a greater ratio of band edge to defect emission, relative to a starting ZnTe layer not subjected to treatment with a metal halide. An untreated layer may have a photoluminescence band edge peak (as measured at 2.25 eV) to defect peak (as measured at 1.75 eV) intensity ratio of 0.02, while a treated layer may have a band edge-to-defect peak intensity ratio of 0.03 to 100 or 0.05 to 10 (see FIG. 11B). In addition, a resultant ZnTe layer may be characterized by a sharper absorption onset near the band gap energy of about 2.3 eV, relative to a ZnTe layer not subjected to a contacting step with a metal halide. A sharper absorption onset is indicated by a steeper slope in a Tauc plot. As shown herein, an untreated ZnTe layer may have a slope in the Tauc plot (absorption coefficient squared (αhν)² versus photon energy) between 0.5·10¹¹ and 2.4·10¹¹ eV cm⁻², or 1.6·10¹¹ and 2.1·10¹¹ eV cm⁻², while a treated layer may have a slope between 2.7·10¹¹ and 1.0·10¹² eV cm⁻², or 3.0·10¹¹ and 4.2·10¹¹ eV cm⁻² (see FIG. 11A).

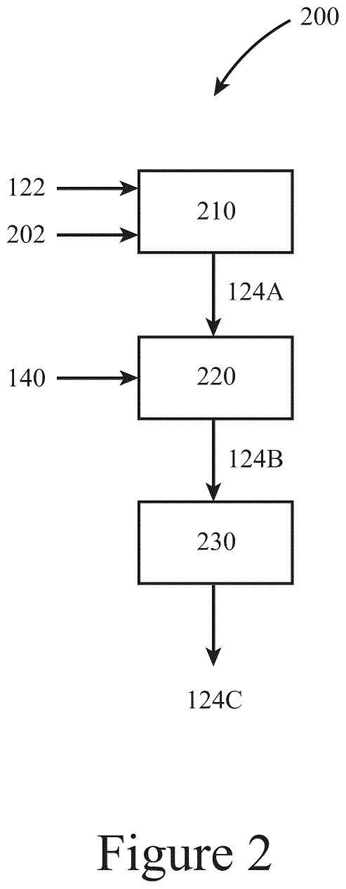

FIG. 2 summarizes the method described above for synthesizing improved ZnTe layers, according to some embodiments of the present disclosure. In brief, a method 200 may include a depositing 210 of a starting ZnTe layer 124A onto a substrate 122 using suitable ZnTe precursors 202 and a suitable deposition method (examples provided above). A starting ZnTe layer 124 positioned on a substrate forms a stack 120. With the starting stack 120 made, a method 200 may proceed to a treating 220 step, as described previously. Here, a solid metal halide 140 is provided, which, together with the stack 120, are heated to different target temperatures, sometimes in an inert environment, that results in the transfer of the gaseous metal halide from the solid metal halide to the surface of the starting ZnTe layer 124, resulting in its transformation to an improved ZnTe layer 124B. A method 200 may then proceed to an optional annealing 230 of the ZnTe layer 124B to produce a final ZnTe layer 124C, which may then be incorporated into a device configured for, among other things, the photoelectrochemical carbon dioxide reduction reaction.

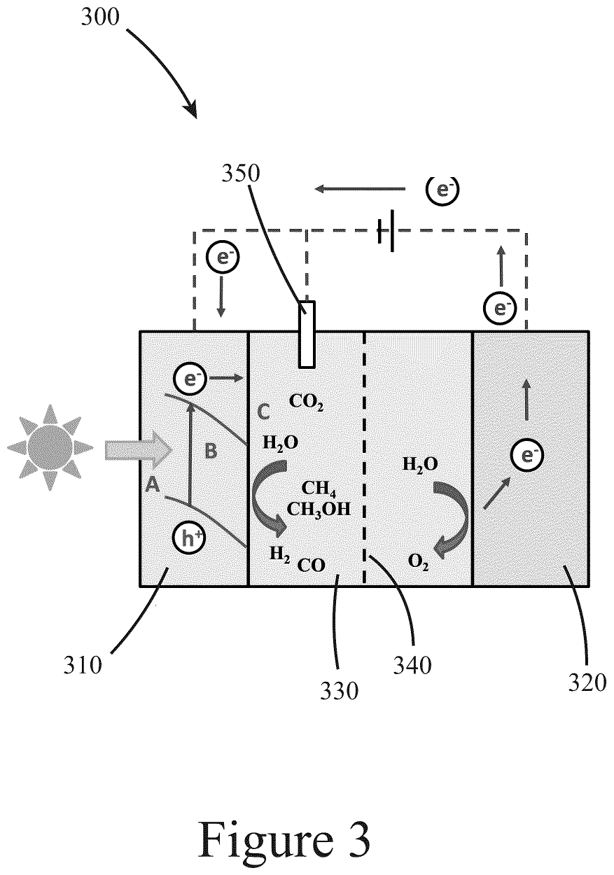

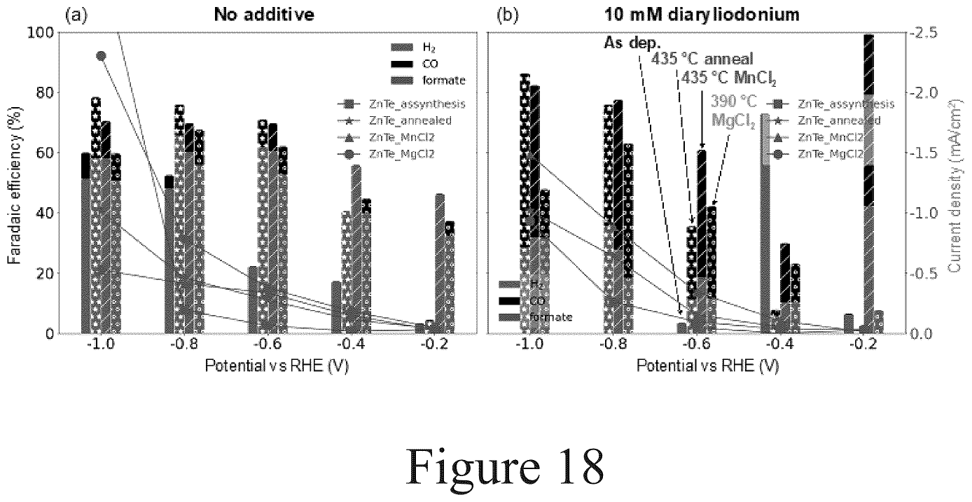

Such a device that incorporates a ZnTe layer and/or ZnTe alloy layer resulting from the methods described herein may be characterized by an increased photocurrent density and Faradaic efficiency (see FIG. 18) for the photoelectrochemical reduction of CO₂ to CO submerged in an inorganic electrolyte in the presence of organic additives (e.g., diaryliodonium, cysteamine, thiols, amines, polypyrrole, N-heterocyclic carbenes, 4-pyridylethylmercaptan, glycine, or N-substituted tetrahydro-bipyridine), when compared to a device that incorporates a ZnTe layer and/or ZnTe alloy layer not subjected to a treating step with a metal halide. FIG. 3 illustrates the basic features of such a device 200, configured for the photoelectrochemical reduction of CO₂ to CO. The exemplary device 200 includes a cathode 310 having a treated ZnTe layer, a Pt counter electrode (anode 320), an electrolyte, a permeable exchange membrane 340, and a reference electrode 350. A similar device using an untreated ZnTe layer demonstrated a photocurrent density between 0 and −1.1 mA/cm², or −0.1 and −1.0 mA/cm² and CO Faradaic efficiency between 0% and 57%, or 10 and 57%. A device using a treated ZnTe layer demonstrated a photocurrent density between −1.2 and −11.3 mA/cm², or −1.5 and −2.0 mA/cm² and CO Faradaic efficiency between 49 and 100%, or 49 and 50% at −1 V vs RHE and 11 mW/cm² illumination (where RHE refers to a reversible hydrogen electrode) (see FIG. 18).

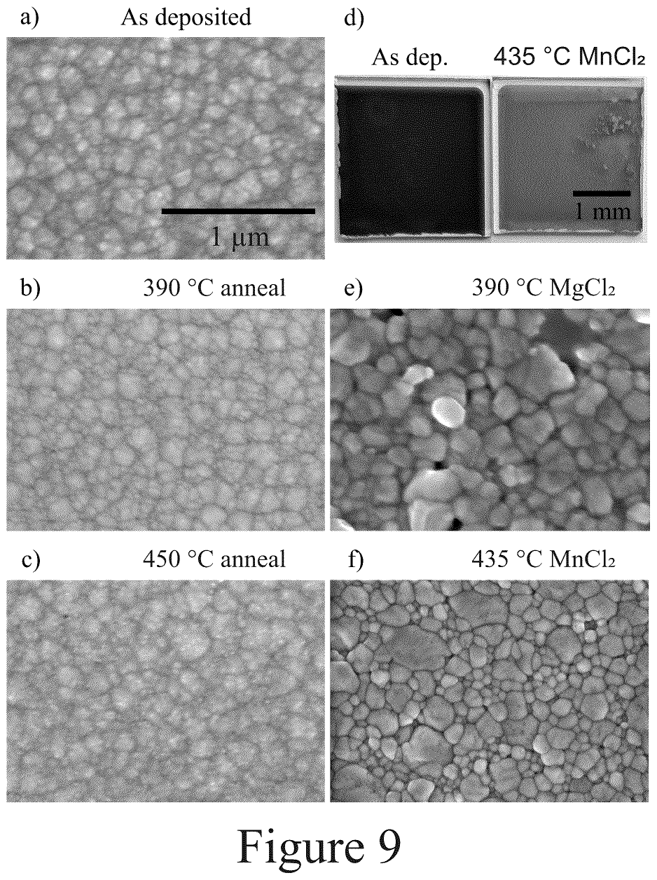

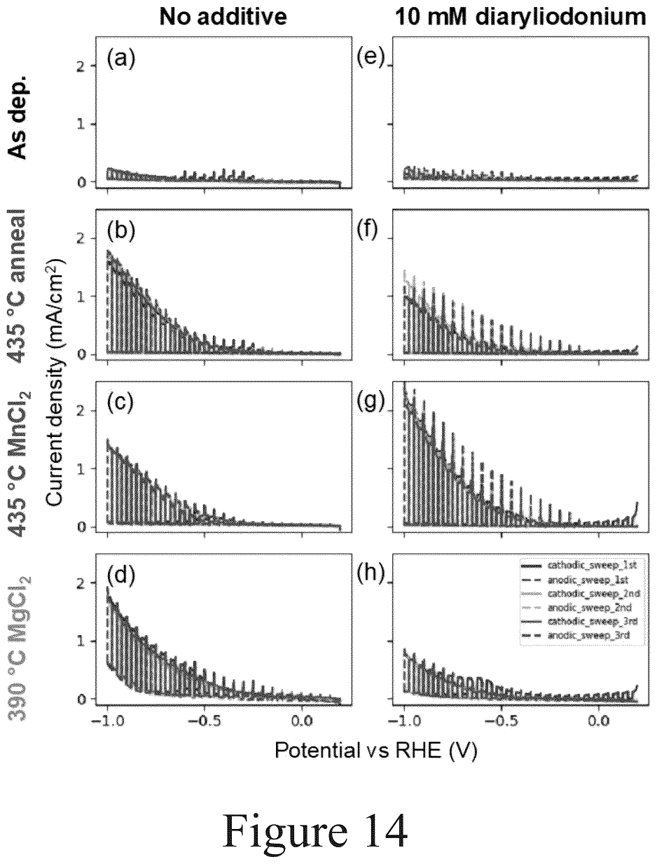

The methods described above were successfully employed to improve the structural and optoelectronic quality of starting ZnTe layers, which demonstrated their photoelectrochemical carbon dioxide reduction reaction (PEC CO₂ RR) capabilities. As described above, heating starting ZnTe layers (deposited by sputtering) in a MnCl₂ atmosphere (treating step 120 in FIG. 2) induced recrystallization, the formation of larger grains (see FIG. 9), and increased the photoluminescence intensity (see FIG. 11B). These halide treatments enhanced the PEC CO₂ RR to a measured photocurrent density that extrapolates to −3.2 to −11.3 mA/cm², or −4.1 to −5.4 mA/cm² at 1 sun illumination and −1.0 V vs reversible hydrogen electrode (RHE), among the highest for planar ZnTe layers. These values may be calculated based on Panel g of FIG. 14 and FIG. 18 based on the equation:

$${J}_{1 s u n} = \frac{{P}_{1 s u n}}{{P}_{m e a s}} \cdot {J}_{m e a s} = \frac{29.8 \frac{mW}{{cm}^{2}}}{11 \frac{mW}{{cm}^{2}}} \cdot ( - 1.5 \frac{m A}{c {m}^{2}} ) = - 4. \frac{m A}{c {m}^{2}}$$

Radio frequency (RF) sputtering was used to deposit ZnTe layers (depositing step 210 in FIG. 2) (·1 μm) at 50 W from a ZnTe target onto substrates held at 170° C. over the course of 70 minutes. The substrate used in the experiments was Tec-15, which is a substrate device stack constructed of the following layers in the order listed: soda-lime glass/SnO₂/SiO₂/F:SnO₂ with the starting ZnT layer deposited on the FTO layer. Other possible substrates include transparent conducting oxides such as indium-doped tin oxide and aluminum-doped tin oxide, as well as various metals such as molybdenum and/or aluminum, either positioned on glass and/or provided as foils. Manganese chloride tetrahydrate (MnCl₂·4H₂O) or magnesium chloride, i.e., examples of solid metal halides 140, (air-exposed MgCl₂ is likely present as MgCl₂·6H₂O) were loaded into a container's 130 a graphite bottom portion 132. Stacks 120 with the starting ZnTe layers 124A were placed above the graphite bottom portion 132 with a solid metal halide 140 with a separation, h, of three mm. The graphite bottom portion 132 and its lid 134 were provided with holes for independent thermocouples. FIG. 1, described above, illustrates a schematic of the experimental set-up used.

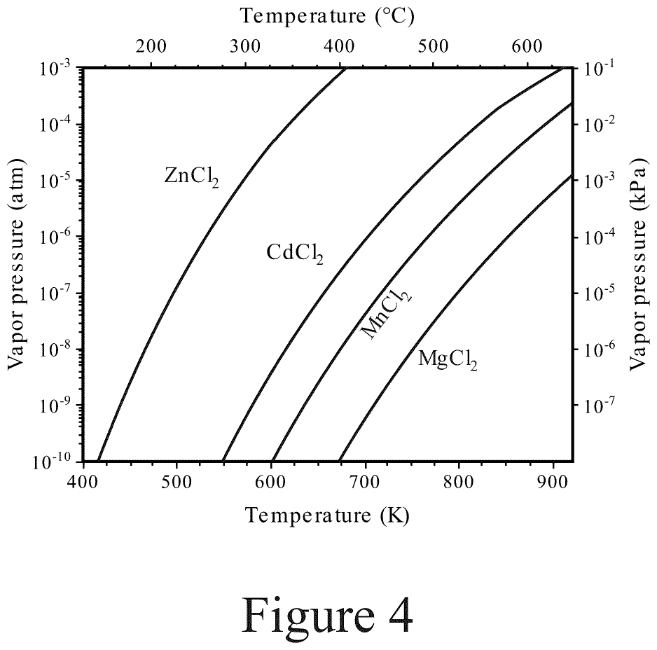

FIG. 4 illustrates vapor pressures as a function of temperature for each of ZnCl₂, CdCl₂, MnCl₂, and MgCl₂. This figure shows that MnCl₂ and MgCl₂ have much lower vapor pressure than ZnCl₂ and CdCl₂, so they will react with the ZnTe absorber at high temperature before re-evaporating. The source (i.e., solid metal halide 140) and the substrate 122 were both positioned within a cold-wall quartz reactor filled with 400 Torr of pure He gas. The metal halide solid and substrate were then pretreated by heating to 200° C. and maintained at that temperature for about 10 minutes to desorb moisture (unless noted). Arrays of 1 kW tungsten-halogen lamps are used to independently control bottom portion 132 (and metal halide source 140) temperature and lid 134 (and substrate 122/ZnTe layer 124) temperature in a cold-wall quartz reactor. The metal halide solid was then heated to a temperature between 400° C. and 550° C. and the substrate to a second temperature about 35° C. cooler (e.g., actual temperatures between 365° C. and 515° C.) than the metal halide solid and these temperatures were maintained for about 30 minutes. Thermochemical equilibrium calculations were performed using Thermo-Calc and the Scientific Group Thermodata Europe (SGTE) 1994 substance database.

Symmetric θ-2θ X-ray diffraction (XRD) were performed with monochromated Cu Kα radiation. ZnTe layer compositions were measured by X-ray fluorescence (XRF) for 60 seconds at 10 locations spread across samples having 1 inch by 1 inch square dimensions. Ultraviolet-visible (UV/visible) spectroscopy was performed using a Cary 6000 spectrophotometer with a diffuse reflectance-integrating sphere. Transmissivity, reflectivity, and thickness data were utilized to construct Tauc plots. After squaring the product of absorptivity (α), Planck's constant (h), and photon frequency (ν), a least-squares fit on the linear region and extrapolate to α=0 was utilized to calculate direct band gap. Room temperature spectrally resolved photoluminescence (PL) was collected using a Raman microscope using a 50× lens with 0.35 numerical aperture and 532 nm laser excitation at 50 μW with a spot size of 40 μm×65 μm (5.1·10¹⁸ photons/cm² s). Room temperature time-resolved photoluminescence (TRPL) was performed by exciting with a 405 nm laser at low fluence (4.2·10¹⁶ photons/cm² s, where 1 sun is 2·10¹⁷ photons/cm² s). Either a 550 nm bandpass filter with a 40 nm full width half maximum or a 700 nm longpass filter at the detector were used to study band edge TRPL and defect emission TRPL, respectively. TRPL data were fitted to bi-exponential functions to extract short and long minority carrier lifetimes (τ₁ and τ₂, respectively).

Devices for performing the photoelectrochemical reduction of CO₂ utilized a 0.1 M KHCO₃ electrolyte, with or without 10 mM diaryliodonium additive, 455 nm light-emitting diode illumination at 11 mW/cm², and 10 mV/s sweeps from +0.2 to −1.0 V vs reversible hydrogen electrode (RHE) for PEC chopped-light cyclic voltammetry (CV) and for chronoamperometry (CA). Multipotential measurements (by CA) were performed following CV to investigate the CO₂ RR product distribution. CA measurements were completed in the order 0, −0.2, −0.4, −0.6, −0.8, and −1 V vs RHE for 15 minutes unless the layer mechanically delaminates. At the end of each (photo)electrolysis, gaseous and liquid products were sampled by a robotic sample handling system (RSHS) and the gas analyzed by chromatography (GC; Thermo Scientific™ TRACE™ 1300) and the liquid analyzed by high-performance liquid chromatography (HPLC; Thermo Scientific UltiMate 3000). Stability due to (photo)corrosion is known to occur in photocathodes for CO₂ RR. All pre- and post-PEC electrolytes were aliquoted at each potential to monitor photocathode dissolution. Inductively coupled plasma mass spectrometry (ICP-MS) by Thermo Fisher Scientific iCAP™ RQ instrument was used to determine the concentration of dissolved metals in electrolytes used for (photo)electrochemistry.

Table 1 and FIG. 4 show that MnCl₂'s vapor pressure is 19 times lower than CdCl₂ at temperatures useful for a chloride treatment (725 K). Moreover, reacting ZnTe with MnCl₂ to form byproducts MnTe and volatile ZnCl₂ is thermodynamically unfavorable (see Table 2). MgCl₂ has an even lower vapor pressure and less favorable Gibbs energy change for the undesired MgTe+ZnCl₂ formation reaction. Therefore, both MnCl₂ and MgCl₂ are attractive for ZnTe chloride treatments because they have diminished volatility and reactivity.

TABLE 1
Vapor pressure of ZnCl₂, CdCl₂, MnCl₂ and
MgCl₂ reactants, showing that MnCl₂ and MgCl₂ avoid the volatility
issue that prevents ZnCl₂ treatment of ZnTe.

| Reactant | P_{vap, 725 K} (·10⁻³ atm) |
|---|---|
| ZnCl₂ | 4.2 |
| CdCl₂ | 2.6 · 10⁻³ |
| MnCl₂ | 1.4 · 10⁻⁴ |
| MgCl₂ | 2.4 · 10⁻⁶ |

TABLE 2
Gibbs energy change for CdCl₂, MnCl₂, or
MgCl₂ reacting with ZnTe, showing that MnCl₂ and
MgCl₂ avoid undesired products such as volatile ZnCl₂.

| Reaction | ΔG_{rxn, 725 K} (kJ/mol) |
|---|---|
| ZnTe + CdCl₂ → ZnCl₂ + CdTe | −15.1 |
| ZnTe + MnCl₂ → ZnCl₂ + MnTe | +67.1 |
| ZnTe + MgCl₂ → ZnCl₂ + MgTe | +129.8 |

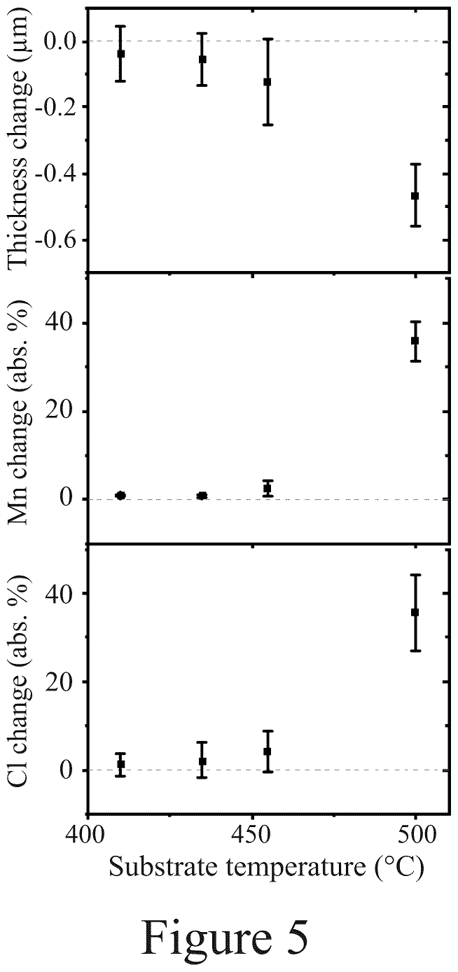

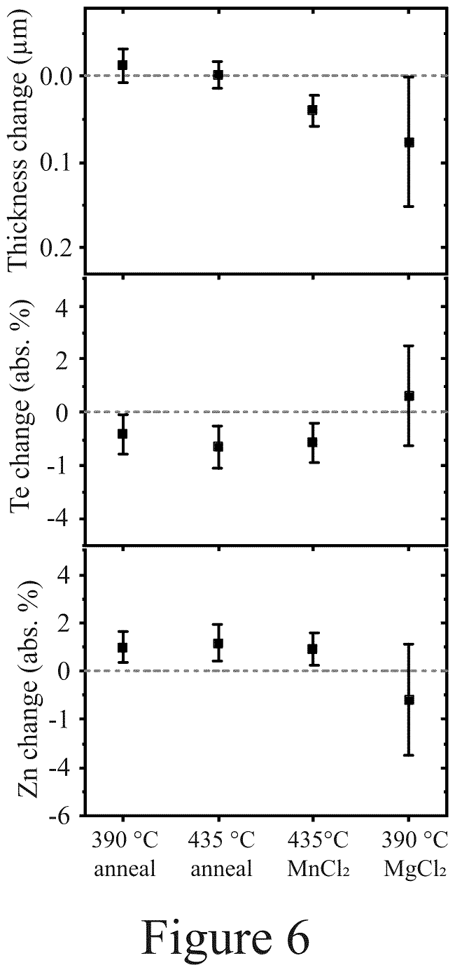

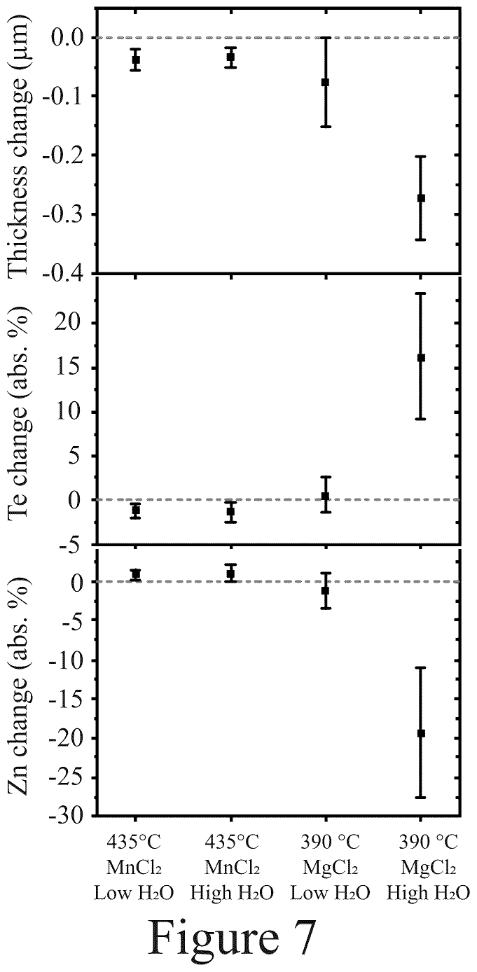

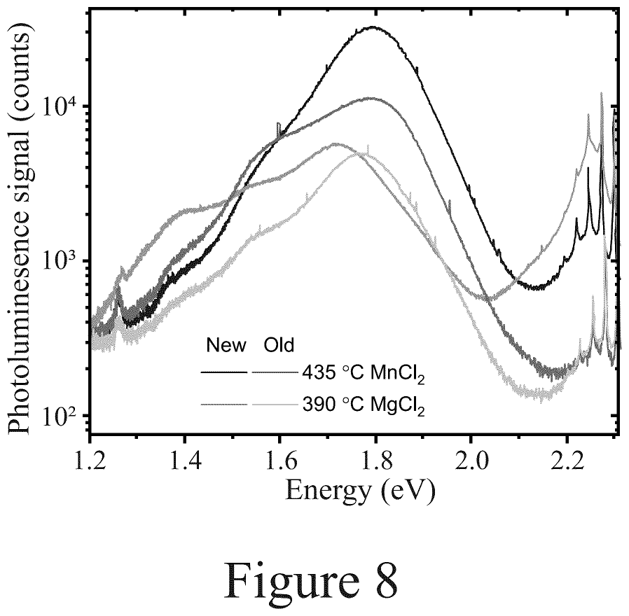

It was determined that MnCl₂ treatments above 475° C. and MgCl₂ treatments above 425° C. etch the ZnTe layer, 435° C. and 390° C. substrate temperatures, respectively, see FIG. 5, so those source temperatures, for heating the solid metal chloride, were chosen for further investigation. To separate thermal and chemical effects, a thermal anneal control was performed using an empty graphite bottom portion (containing no chloride source material). The anneals did not decrease ZnTe layer thickness by XRF, but they did slightly decrease Te content (see FIG. 6). On the other hand, the MnCl₂ and MgCl₂ treatments decreased ZnTe layer thickness and caused more significant Zn loss, indicating that etching occurs via ZnCl₂ formation (see FIG. 6). When the MgCl₂ was left in air instead of in a N₂-flow dry box and the pre-annealing step was skipped, more H₂O was allowed into the system, which resulted in more etching occurring (see FIG. 7). The 200° C. pre-anneal desorbed all 6 H₂O molecules from MgCl₂·6H₂O¹⁶ and only 3 H₂O molecules from MnCl₂·4H₂O,²⁶ so the effect was small for the latter (see FIG. 7). HCl is expected to form from the sources making hydrochloric acid in the presence of moisture to facilitate etching. It was also determined that repeated thermal cycling of the MnCl₂ and MgCl₂ solids reduced the resulting layers' PL peak intensities (see FIG. 8), indicating that the metal halide solids' reactivity eventually diminishes, probably due to chlorine loss via HCl formation.

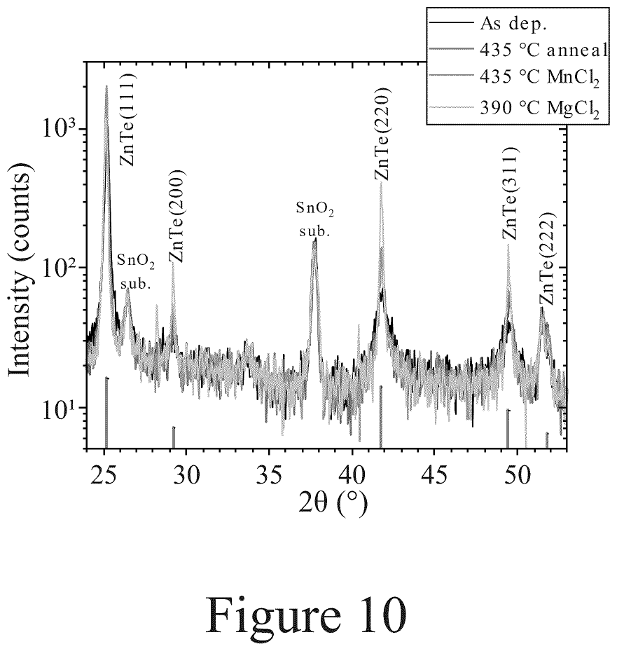

Grain size and morphology resulting from chloride treatments are illustrated in FIG. 9. The as-deposited layers had small grains in a range between 50 nm and 200 nm in diameter. Since deposition was performed at 170° C., the anneals (e.g., heating) did not increase the apparent grain size much. Relative to the anneals, the chloride treatments increased grain size 50 to 500 nm and formed smoother surfaces. As-deposited ZnTe layers were polycrystalline in nature, with a (111) preferential orientation compared to the randomly oriented XRD reference pattern from ICSD. Annealing and chloride treatments enhanced crystallinity by XRD as evidenced by an increase in peak intensity by a factor of 1.5 to 20, or 1.9 to 5.8 (see FIG. 10).

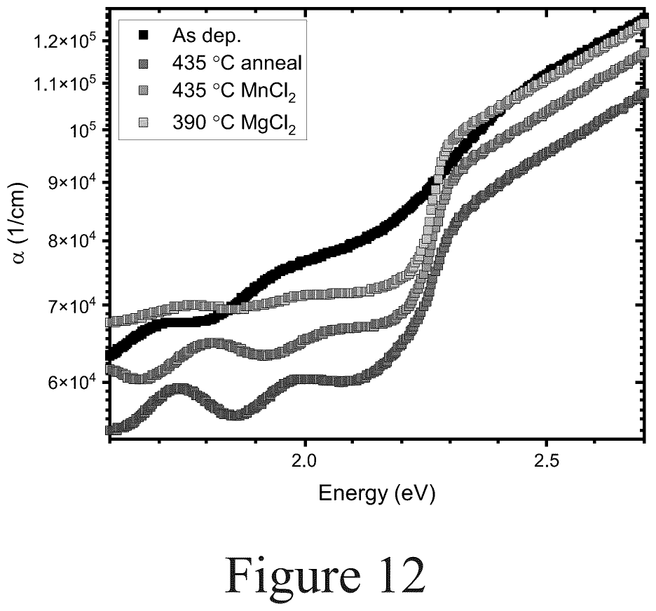

As-deposited ZnTe layers exhibited a finite signal absorption near the 2.2 eV band edge and almost no PL response (130 to 150 counts at the peak relative to 80 to 110 counts in the background) (see FIG. 11B). Annealing sharpened the absorption onset by UV/visible spectroscopy from about 1.6·10¹¹ to about 2.1·10¹¹ eV cm⁻² and the chloride treatments sharpened the absorption onset even more from about 3.0·10¹¹ to about 4.2·10¹¹ eV cm⁻² (see FIG. 12 and FIG. 11A). In addition, annealing enhanced the defect PL emission at 1.75 eV from between 130 counts and 190 counts to between 36,300 counts and 42,500 counts (see FIG. 11B). That energy may be consistent with an oxygen-related localized defect. The chloride treatments enhanced band edge PL emission at 2.25 eV, relative to the anneals illustrated in FIG. 11B. In summary, the best performing MnCl₂ and MgCl₂ treatments recrystallize ZnTe by balancing the formation of ZnCl₂ with its evaporative loss, enhancing grain size, absorption onset, and band edge PL emission.

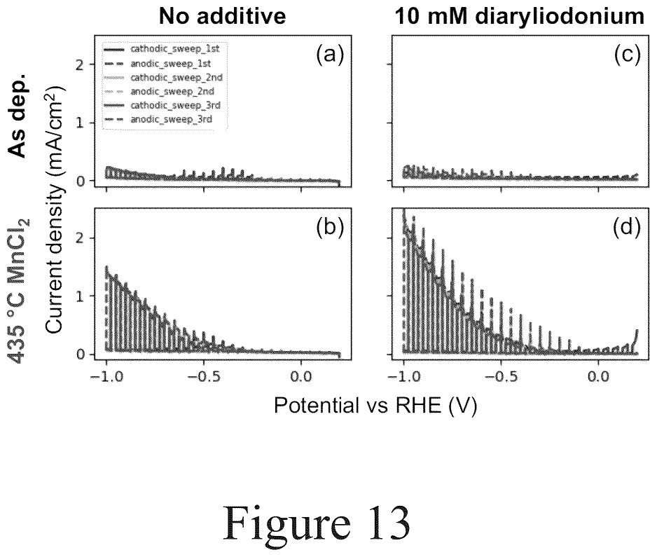

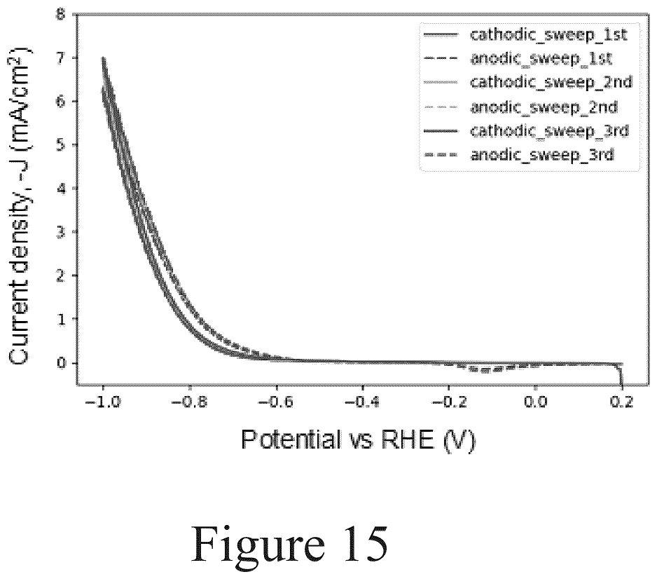

To evaluate the performance of the four ZnTe photocathodes investigated herein, CV cycles were performed followed by multiple CA measurements using the high throughput analytical electrochemistry (HT-ANEC) instrument. The CV scans revealed that the annealed and MnCl₂-treated absorbers had similar low dark currents and much higher photocurrents (between 1.0 mA/cm² and 2.1 mA/cm² at −1.0 V vs RHE) compared to as-deposited samples (0.2 mA/cm² at −1.0 V vs RHE) (see FIGS. 13 and 14). Chopped light CV scans were also performed on bare F:SnO₂ substrates, which demonstrated dark currents at potentials more negative than −0.7 V vs RHE but no photocurrents in the potential range tested (see FIG. 15). The enhanced dark current in the MgCl₂-treated ZnTe samples (see FIG. 14) probably stems from the underlying substrate, which is more exposed in that sample due to etching-induced pinholes in the ZnTe. Additionally, all samples had a reductive current between −0.25 and −0.6 V vs RHE but present only in the 1^{st} cycle of the cathodic sweep. The cause of these reductive currents could be the reduction of native oxides on the surface of the ZnTe (e.g., TeOₓ or ZnO) during PEC testing.

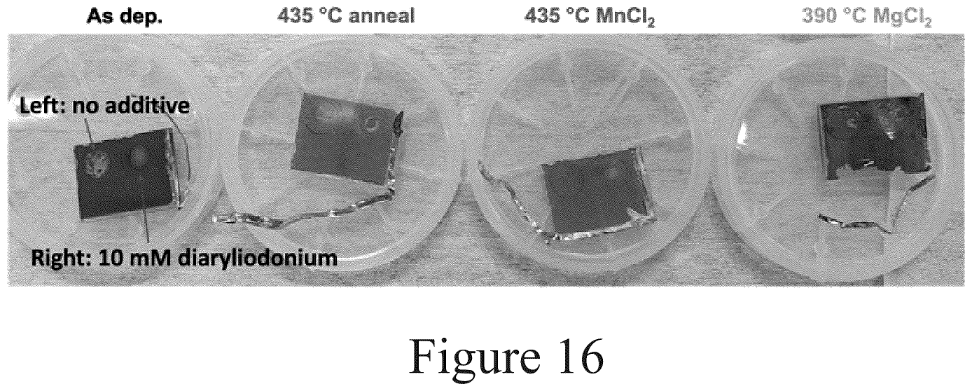

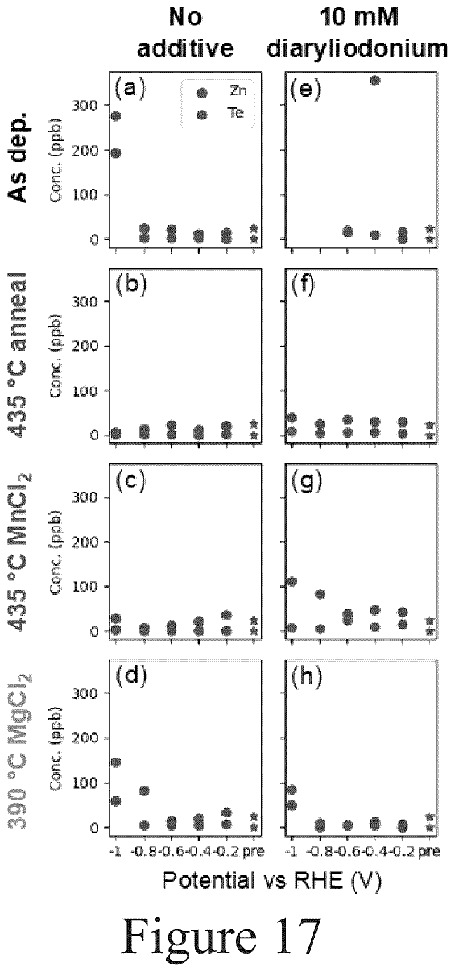

The observation of a negligible dark current in these CV experiments down to −1.0 V vs RHE guided the choice of subsequent operating potentials between −0.2 and −1.0 V vs RHE, such that the only current measured under illumination can be assumed to be the photocurrent. The higher photocurrents from the annealed and metal halide-treated absorbers in the following CA measurements agree with those seen in the above CV scans. It is noted that the very high current at −1.0 V vs RHE seen in the as deposited sample was from the (dark) current of the F:SnO₂ substrate since its ZnTe layer was totally delaminated after multi-potential CA tests (see FIG. 16). Carbon monoxide (CO) was the only CO₂ RR product and was minor while H₂ was the major product over all four photocathodes and at all potentials tested. In the low bias regions CO might be below the GC detection limit and hence not accounted for in Faradaic efficiency calculations (although there is likely no CO formation at these potentials). The higher applied bias regions have CO Faradaic efficiency of approximately 10%. ICP-MS data were collected on the post-PEC electrolyte at each potential to evaluate if any dissolution of ZnTe occurred during the PEC tests (see FIG. 17). Compared to the pre-PEC concentrations (star symbols), the post-PEC electrolytes show that all sample types of ZnTe layers were stable for most conditions. The very high Zn concentration seen (mainly) for high bias regions is more likely due to (slight) layer delamination (see FIG. 16) and it occurred in only a few samples.

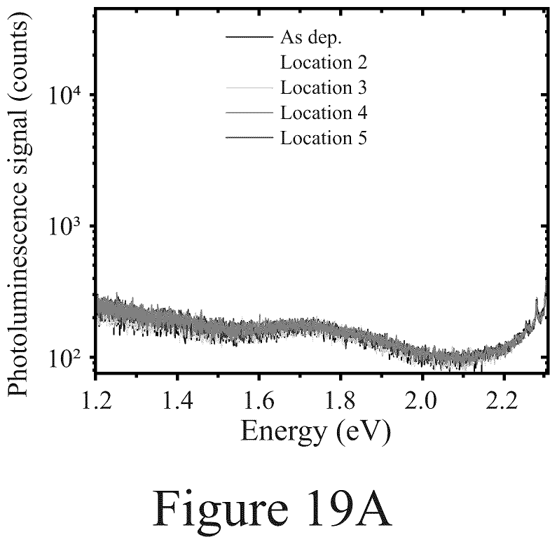

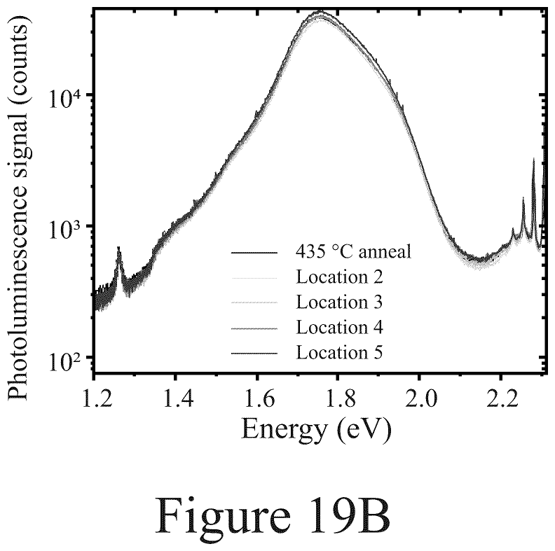

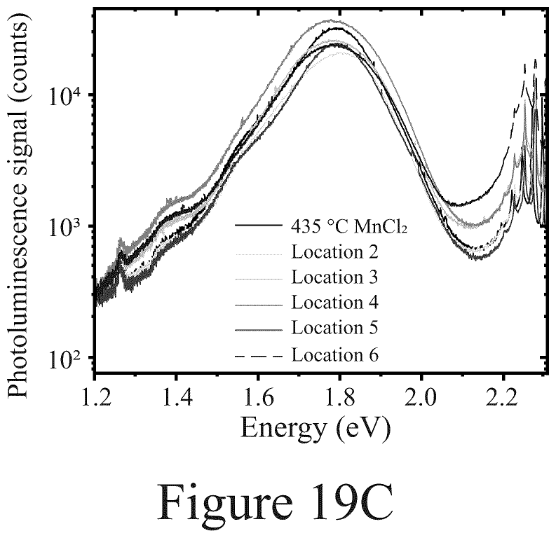

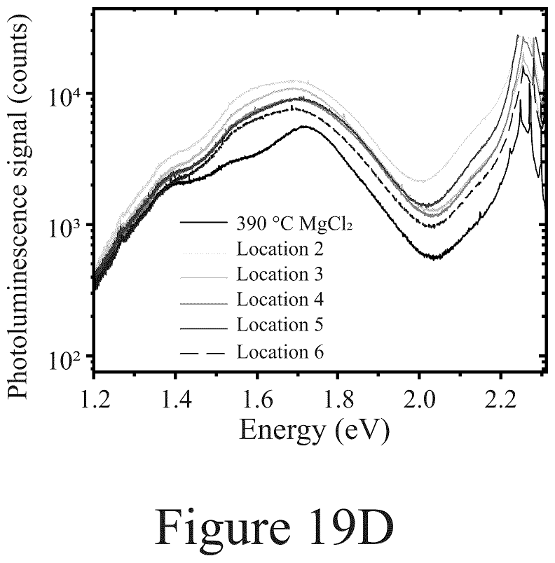

Adding the 10 mM diaryliodonium into electrolytes suppressed current density of all samples, including the dark current from the MgCl₂-treated sample, as illustrated in FIG. 14 and FIG. 18 (both CV and CA). Additives like diaryliodonium have been shown to reduce and dimerize/oligomerize into a non-conductive layer on the electrode surface to enhance CO₂ RR product selectivity by suppressing HER which leads to reduced total photocurrents. However, the MnCl₂-treated ZnTe sample is an exception, with photocurrent increasing slightly with the additive. This is probably due to sample nonuniformity, as additional PL measurements on several sample locations showed that the chloride treatments introduced nonuniformity in optoelectronic quality (see FIGS. 19A-19D). More uniform metal halide solid material may eliminate this situation in the future. The photocurrent density achieved for the MnCl₂-treated sample when the additive is present up to −1.5 mA/cm² at −1.0 V vs RHE and 11 mW/cm² illumination with a 455 nm LED.

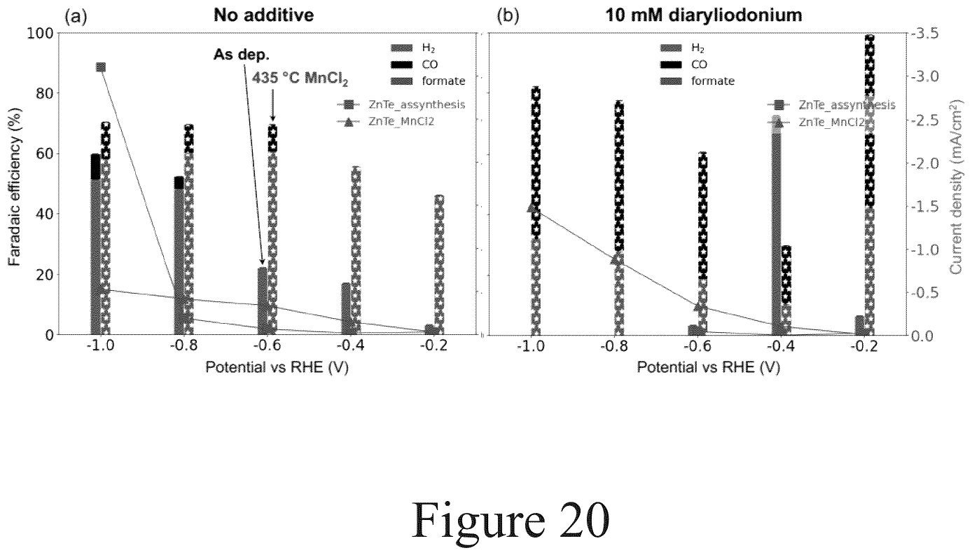

The diaryliodonium additive increased Faradaic efficiency of CO formation substantially for all sample types (see FIG. 20 and FIG. 18) and made the CO₂ RR the major reaction in comparison to HER. With this enhanced CO selectivity, the MnCl₂-treated ZnTe absorber with additive achieved a Faradaic efficiency of 50.4% with a photocurrent density of −1.5 mA/cm² at −1 V vs RHE. For a 2.16 eV MnCl₂-treated ZnTe absorber (band gap measured as shown in FIG. 8), a 1 sun AM1.5G solar resource had 29.8 mW/cm² of above-band gap photons. Therefore, the −1.5 mA/cm² photocurrent density measured at 11 mW/cm² of 455 nm LED illumination extrapolates to −4.0 mA/cm² at 1 sun AM1.5G. Further, adding Cu, Ag, or Au catalysts may be routes to build on the bulk property improvements of the chloride treatments and further enhance ZnTe absorbers for PEC CO₂ RR.

TABLE 3
Summary of ZnTe absorber sample properties: Tauc plot slope (absorption onset),
defect PL intensity (counts at 1.75 eV), band edge PL intensity (counts at 2.25 eV),
PEC photocurrent density at −1.0 V vs RHE and 11 mW/cm² illumination,
PEC photocurrent density at −1.0 V vs RHE extrapolated to 1 sun illumination,
CO₂ to CO Faradaic efficiency at −1.0 V vs RHE and 11 mW/cm² illumination.

| | | | | | PEC | |
|---|---|---|---|---|---|---|
| | | | | PEC | photocurrent | |
| | Tauc plot | Defect | Band | photocurrent | density at 1 | Faradaic |
| | slope (·10¹¹ | PL | edge PL | density | sun | efficiency |
| Sample | eV cm⁻²) | (counts) | (counts) | (mA/cm²) | (mA/cm²) | (%) |
| As dep. | 1.6 | 170 | 160 | −0.1 | −0.3 | 0 |
| 435° C. | 2.1 | 38,300 | 820 | −1.0-−1.1 | −2.7-−3.0 | 57 |
| anneal | | | | | | |
| 435° C. | 3.0 | 31,500 | 1,510 | −1.5-−2.0 | −4.1-−5.4 | 50 |
| MnCl₂ | | | | | | |

### EXAMPLES

Example 1. A method comprising: treating a layer comprising ZnTe with a metal halide, wherein: the layer has a first grain size between 25 nm and 250 nm before the treating and the layer has a second grain size after the treating that is larger than the first grain size.

Example 2. The method of Example 1, wherein the ZnTe comprises at least one of Zn_{1-w}Cd_{w}Te, ZnTe₁₋ₓSeₓ, Zn_{1-y}Cd_{y}Te_{1-z}Se_{z}, or a combination thereof and each of w, x, y, and z are independently between 0 and 0.9, inclusively.

Example 3. The method of either one of Example 1 and/or Example 2, wherein the metal of the metal halide comprises at least one of magnesium, manganese, or a combination thereof.

Example 4. The method of any one of Examples 1-3, wherein the halide of the metal halide comprises at least one of chloride, bromide, iodide, or a combination thereof.

Example 5. The method of any one of Examples 1-4, wherein the metal chloride comprises at least one of MnCl₂, MgCl₂, or a combination thereof.

Example 6. The method of any one of Examples 1-5, wherein the metal halide has a vapor pressure lower than the vapor pressure of a zinc halide comprising the same halide as the metal halide.

Example 7. The method of any one of Examples 1-6, wherein the vapor pressure of the metal halide is less than the vapor pressure of ZnCl₂.

Example 8. The method of any one of Examples 1-6, wherein the metal halide has a positive Gibbs free energy of reaction with the ZnTe.

Example 9. The method of any one of Examples 1-8, wherein the second grain size is between 50 nm and 1,000 nm or between 50 nm and 500 nm.

Example 10. The method of any one of Examples 1-9, wherein the treating is performed by close space sublimation.

Example 11. The method of any one of Examples 1-10, wherein, during the treating, the metal halide is contacting the ZnTe while in a gaseous state.

Example 12. The method of any one of Examples 1-11, wherein the treating is performed with the layer at a first temperature between 300° C. and 600° C. or between 365° C. and 515° C. or less than about 435° C.

Example 13. The method of any one of Examples 1-12, wherein the treating is performed at a pressure between 1 Torr and 1,520 Torr or between 100 Torr and 800 Torr.

Example 14. The method of any one of Examples 1-13, wherein the treating is performed in a gaseous environment comprising the metal halide.

Example 15. The method of any one of Examples 1-14, wherein the gaseous environment further comprises at least one of He, Ar, H₂, H₂O, O₂, N₂, HCl, or a combination thereof.

Example 16. The method of any one of Examples 1-15, wherein the gaseous environment further comprises H₂.

Example 17. The method of any one of Examples 1-16, wherein a concentration of H₂ in the gaseous environment is between 0.5 vol % and 10 vol %.

Example 18. The method of any one of Examples 1-17, further comprising: prior to the treating, loading a solid comprising the metal halide into a bottom portion of a container and heating the solid to a second temperature, wherein: the second temperature is higher than the first temperature, and the heating converts the solid to a gas.

Example 19. The method of any one of Examples 1-18, further comprising, prior to the treating, depositing the layer onto a substrate.

Example 20. The method of any one of Examples 1-19, wherein the depositing is performed by at least one of radio frequency sputtering, molecular beam epitaxy, chemical vapor deposition, pulsed laser deposition, or a combination thereof.

Example 21. The method of any one of Examples 1-20, wherein the depositing is performed by solution processing.

Example 22. The method of any one of Examples 1-21, wherein the solution processing includes the hydrothermal growth of ZnTe using Zn foil in water containing a Te precursor such as NaTeO₃ as well as NaBH₄.

Example 23. The method of any one of Examples 1-22, wherein the substrate comprises at least one of glass, SiO₂, SnO₂, a fluorine-doped SnO₂, polymer foil, metal foil, Si, or a combination thereof.

Example 24. The method of any one of Examples 1-23, wherein, after the treating, the layer has a thickness between 0.1 μm and 5 μm.

Example 25. The method of any one of Examples 1-24, wherein during the treating the solid comprising the metal halide sublimes, resulting in the transfer of the gas to the layer.

Example 26. The method of any one of Examples 1-25, wherein the solid metal halide is positioned from the layer at a distance between greater than 0 mm and 5 mm or 0.25 mm to 3 mm.

Example 27. The method of any one of Examples 1-26, wherein the solid metal halide is positioned in the bottom portion at a thickness between 0.5 mm and 5 mm or between 2 mm and 3 mm.

Example 28. The method of any one of Examples 1-27, further comprising after the treating, annealing the ZnTe layer resulting from the treating.

Example 29. The method of any one of Examples 1-28, wherein the annealing is performed at a temperature between 300° C. and 550° C.

Example 30. The method of any one of Examples 1-29, wherein the treating enhances a photoluminescence band-edge-to-defect emission ratio of the layer.

Example 31. The method of any one of Examples 1-30, further comprising after the treating, depositing a catalyst layer on the ZnTe layer resulting from the treating.

Example 32. The method of any one of Examples 1-31, wherein the catalyst layer comprises at least one of copper, silver, gold, or a combination thereof.

Example 33. A composition comprising: a layer comprising ZnTe, wherein: the layer comprises grains having a grain size between 50 nm and 1,000 nm or between 50 nm and 500 nm.

Example 34. The composition of Example 33, wherein the grains extend substantially through the entire thickness of the layer.

Example 35. The composition of either one of Example 33 and/or Example 34, wherein grains have columnar shape in the direction of the thickness of the layer.

Example 36. The composition of any one of Examples 33-35, wherein the layer is characterized by an XRD spectrum with relative peak intensities that correspond to random grain orientations (less texture; less preferred grain orientation).

Example 37. The composition of any one of Examples 33-36, wherein the layer is characterized by a more intense photoluminescence emission near the band gap energy of about 2.3 eV, relative to the defect emission between 1.4 eV and 1.9 eV.

Example 38. The composition of any one of Examples 33-37, wherein the layer is characterized by a sharper absorption onset near the band gap energy of about 2.3 eV.

Example 39. The composition of any one of Examples 33-38, wherein the layer is characterized by a surface roughness less than 30 nm or less than 20 nm root-mean-square.

Example 40. The composition of any one of Examples 33-39, wherein the layer is characterized by a photoluminescence band-edge emission at about 2.25 eV and a defect emission between 1.4 eV and 1.9 eV, and a ratio of the band-edge-to-defect emission intensities is between 0.03 and 100.

Example 41. The composition of any one of Examples 33-40, wherein the ratio is between 0.05 and 10.

Example 42. The composition of any one of Examples 33-41, wherein the layer is characterized by an absorption onset near 2.3 eV with a Tauc-plot slope between 2.7×10¹¹ and 1.0×10¹² eV cm⁻².

Example 43. A device comprising: a cathode comprising a layer comprising ZnTe, wherein: the layer has a grain size between 50 nm and 500 nm, and an increased photocurrent density and Faradaic efficiency for the photoelectrochemical reduction of CO₂ to CO.

Example 44. The device of Example 43, further comprising: an electrolyte; and an anode, wherein: the cathode and the anode are positioned within the electrolyte.

Example 45. The device of either Example 43 and/or Example 44, further comprising an additive positioned within the electrolyte.

Example 46. The device of any one of Examples 43-45, wherein the additive comprises at least one of a thiol, an amine, an N-heterocyclic carbene, 4-pyridylethylmercaptan, glycine, an N-substituted tetrahydro-bipyridine, or a combination thereof.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, 0.4%, ±0.3%, ±0.2%, or ±0.1% of a specific numeric value or target.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A method comprising:
treating a layer comprising ZnTe with a metal halide, wherein:
the layer has a first grain size between 25 nm and 250 nm before the treating, and
the layer has a second grain size after the treating that is larger than the first grain size.

2. The method of claim 1, wherein the ZnTe comprises at least one of Zn_{1-w}Cd_{w}Te, ZnTe₁₋ₓSeₓ, Zn_{1-y}Cd_{y}Te_{1-z}Se_{z}, or a combination thereof and each of w, x, y, and z are independently between 0 and 0.9, inclusively.

3. The method of claim 1, wherein the metal of the metal halide comprises at least one of magnesium, manganese, or a combination thereof.

4. The method of claim 1, wherein the halide of the metal halide comprises at least one of chloride, bromide, iodide, or a combination thereof.

5. The method of claim 1, wherein the metal chloride comprises at least one of MnCl₂, MgCl₂, or a combination thereof.

6. The method of claim 1, wherein the second grain size is between 50 nm and 1,000 nm.

7. The method of claim 1, wherein the treating is performed by close space sublimation.

8. The method of claim 1, wherein the treating is performed with the layer at a first temperature between 300° C. and 600° C.

9. The method of claim 1, wherein the treating is performed at a pressure between 1 Torr and 1,520 Torr.

10. The method of claim 1, wherein the treating is performed in a gaseous environment comprising the metal halide.

11. The method of claim 10, wherein the gaseous environment further comprises at least one of He, Ar, H₂, H₂O, O₂, N₂, HCl, or a combination thereof.

12. The method of claim 11, wherein the gaseous environment further comprises H₂.

13. The method of claim 12, wherein a concentration of H₂ in the gaseous environment is between 0.5 vol % and 10 vol %.

14. The method of claim 8, further comprising:
prior to the treating, loading a solid comprising the metal halide into a bottom portion of a container and heating the solid to a second temperature, wherein:
the second temperature is higher than the first temperature, and
the heating converts the solid to a gas.

15. The method of claim 1, wherein the treating enhances a photoluminescence band-edge-to-defect emission ratio of the layer.

16. The method of claim 1, further comprising, after the treating, depositing a catalyst layer on the ZnTe layer resulting from the treating.

17. The method of claim 1, wherein the catalyst layer comprises at least one of copper, silver, gold, or a combination thereof.

18. A composition comprising:
a layer comprising ZnTe, wherein:
the layer comprises grains having a grain size between 50 nm and 1,000 nm or between 50 nm and 500 nm.

19. A device comprising:
a cathode comprising a layer comprising ZnTe, wherein:
the layer has a grain size between 50 nm and 500 nm, and
an increased photocurrent density and Faradaic efficiency for the photoelectrochemical reduction of CO₂ to CO.

20. The device of claim 19, further comprising:
an electrolyte; and
an anode, wherein:
the cathode and the anode are positioned within the electrolyte.
